(19) United States
(12) Patent Application Publication
(10) Pub. No.: US 2017/0073064 A1
(43) Pub. Date: Mar. 16, 2017

(54) ROTOR SYSTEM STRUCTURAL FAULT ESTIMATION

(71) Applicant: SIKORSKY AIRCRAFT CORPORATION, STRATFORD, CT (US)

(72) Inventor: Joshua D. Isom, Allentown, PA (US)

(21) Appl. No.: 15/309,361

(22) PCT Filed: Mar. 5, 2015
(86) PCT No.: PCT/US15/18858

§ 371 Date: Nov. 7, 2016

Related U.S. Application Data
(60) Provisional application No. 61/989,583, filed on May 7, 2014.

(51) Int. Cl. B64C 27/00; G07C 5/08; G05B 23/02; G01L 5/13

(52) U.S. Cl. CPC B64C 27/006; G01L 5/133; G07C 5/085; G05B 23/0221; G05B 23/0224

(57) ABSTRACT

One aspect is a structural fault estimation system for a rotor system. The structural fault estimation system includes a plurality of sensors operable to provide a plurality of measured rotor loads and motion of the rotor system. A rotor loads and motion estimator is operable to produce a plurality of estimated rotor loads and motion for the rotor system. A rotor fault estimator is operable to determine residual rotor loads and motion as a difference between the measured rotor loads and motion and the estimated rotor loads and motion, and estimate fault magnitudes for the rotor system using least squares relative to fault models and the residual rotor loads and motion. The structural fault estimation system can perform structural fault estimation in real-time on an aircraft while in operation.

### GOVERNMENT RIGHTS

This invention was made with government support under contract number W911W6-10-2-0006 awarded by the United States Army. The government has certain rights in the invention.

### BACKGROUND OF THE INVENTION

Embodiments of the invention generally relate to aircraft health monitoring, and more particularly, to rotor system structural fault estimation for a rotary wing aircraft.

Aircraft have a large number of structural components that are subject to intense structural usage. These components are often expensive to replace. Conventional structural health management policies replace components after a fixed number of flight hours on a given aircraft, regardless of the actual structural usage of the components on the given aircraft. Since the structural components may have a measurable and predictable life cycle, prediction of component deterioration so as to anticipate a potential failure facilitates prolonged operations. Early detection of potential failures or fractures within a structural component provides the ability to perform preventative maintenance and avoid potential component failure.

Some aircraft incorporate Health and Usage Monitoring Systems (“HUMS”) to monitor the health of critical components and collect operational flight data utilizing on-board sensors and avionics systems. HUMS can create large volumes of data, which may vary in frequency and duration depending on the components monitored. Virtual load monitoring can be used to derive additional monitored values beyond those directly provided by HUMS sensors. While a number of measured and estimated load and motion parameters can be determined for an aircraft, extracting fault estimations rapidly and reliably can be difficult particularly when considering a number of potential faults with varying potential magnitude.

### SUMMARY OF THE INVENTION

According to one embodiment, a structural fault estimation system for a rotor system is provided. The structural fault estimation system includes a plurality of sensors operable to provide a plurality of measured rotor loads and motion of the rotor system. A rotor loads and motion estimator is operable to produce a plurality of estimated rotor loads and motion for the rotor system. A rotor fault estimator is operable to determine residual rotor loads and motion as a difference between the measured rotor loads and motion and the estimated rotor loads and motion, and estimate fault magnitudes for the rotor system using least squares relative to fault models and the residual rotor loads and motion. The structural fault estimation system can perform structural fault estimation in real-time on an aircraft while in operation.

In addition to one or more of the features described above or below, or as an alternative, the fault model in further embodiments could include a library of fault signatures for a plurality of structural faults of the rotor system. The estimated fault magnitudes can be isolated as separate fault conditions per rotor blade of the rotor system.

In addition to one or more of the features described above or below, or as an alternative, in further embodiments the estimated rotor loads and motion for the rotor system are estimates based on an increased sampling frequency of aircraft state parameters. The aircraft state parameters may be updated once per main rotor revolution of the rotor system. A sample rate of the estimated rotor loads and motion can be normalized to align with a sample rate of the measured rotor loads and motion.

In addition to one or more of the features described above or below, or as an alternative, further embodiments could include a fault detector that applies a cumulative sum detector to identify persistent fault changes over time for each of the estimated fault magnitudes. The cumulative sum detector may declare a fault condition when a cumulative sum of a corresponding estimated fault magnitude exceeds a cumulative fault threshold.

According to another embodiment, a method of rotor system structural fault estimation is provided. A plurality of measured rotor loads and motion of a rotor system is received from a plurality of sensors. A plurality of estimated rotor loads and motion is produced for the rotor system based on aircraft state parameters. Residual rotor loads and motion are determined as a difference between the measured rotor loads and motion and the estimated rotor loads and motion. Fault magnitudes are estimated for the rotor system using least squares relative to fault models and the residual rotor loads and motion. The method can be performed in real-time on an aircraft while in operation.

In addition to one or more of the features described above, or as an alternative, in further embodiments a cumulative sum detector can be applied to identify persistent fault changes over time for each of the estimated fault magnitudes. A fault condition may be declared when a cumulative sum of a corresponding estimated fault magnitude exceeds a cumulative fault threshold.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic diagram of an aircraft in accordance with embodiments;

FIG. 2 is a data flow diagram for rotor system structural fault estimation according to an embodiment;

FIG. 3 depicts an example of fault magnitude variation over a range of angles for one example rotor system fault in accordance with embodiments;

FIG. 4 is a schematic diagram of an exemplary structural fault estimation system according to an embodiment; and

FIG. 5 is a process flow diagram for structural fault estimation according to an embodiment.

The detailed description explains embodiments of the invention, together with advantages and features, by way of example with reference to the drawings.

### DETAILED DESCRIPTION OF THE INVENTION

Embodiments provide rotor system structural fault estimation. In exemplary embodiments, rotor system loads and motion measurements are acquired for an aircraft, e.g., a rotary wing aircraft. Virtual monitoring of loads is performed to estimate the same loads and motions based on the aircraft state, and the estimated loads are subtracted from the actual loads to produce a residual. A library of fault perturbation modes is used with least squares to estimate the magnitude of each fault based on the loads and motion residual. Examples of rotor system structural faults that can be measured and monitored based on rotor system loads and motion include wear in a pitch control rod end bearing, viscous damper degradation, and stiffness degradations of elastomeric flap/lag/pitch bearings.

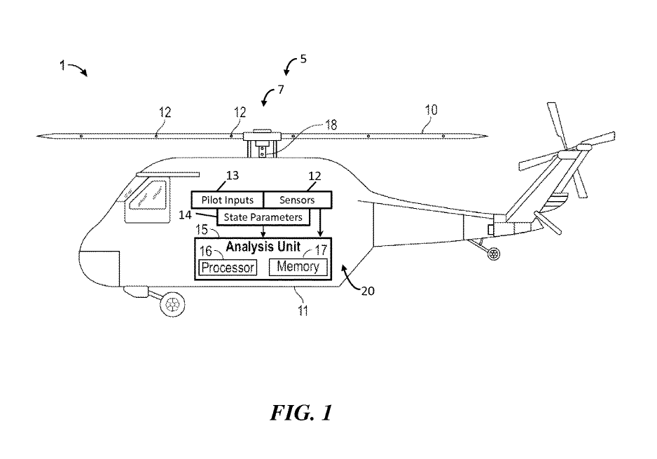

FIG. 1 illustrates an aircraft 1 as a rotary wing aircraft, e.g., a helicopter including a rotor system 5. The rotor system 5 includes a main rotor 7 having a plurality of rotor blades 10 coupled to a rotor shaft 18, along with other support and actuation structures known in the art (not depicted). In alternate embodiments, the rotor system 5 can include multiple rotors (e.g., a dual rotor/coaxial rotor system). The aircraft 1 includes a plurality of sensors 12 in the rotor blades 10 and the rotor shaft 18 to monitor the rotor system 5. The sensors 12 can also be distributed elsewhere within the aircraft 1. The sensors 12 may include, for example, strain gauges, magnetic Hall Effect sensors, temperature sensors, pressure sensors, magnetostrictive sensors, accelerometers, and rate gyros. In an exemplary embodiment, the sensors 12 monitor the rotor blades 10 and rotor shaft 18 to sense the loads and motion of the rotor blades 10 and rotor shaft 18, and the effect of perturbations in the aircraft state on the rotor blades 10 and rotor shaft 18. Perturbations in aircraft state can result in changes in the loads and motion of the rotor blades 10 and rotor shaft 18 including changes in blade flap, blade pitch, blade lead lag, main rotor shaft bending, main rotor shaft torque, and pitch rod loads, for example.

In an exemplary embodiment, a structural fault estimation system 20 includes an analysis unit 15 that is wired or wirelessly linked to the sensors 12. The analysis unit 15 can include a processor 16 to process the sensed data and determine the loads and motion of the rotor system 5. The analysis unit 15 may further include memory 17, supporting logic, and other circuitry necessary to analyze the sensor data and store and transmit the analyzed data. Examples of memory and supporting logic include hard disks, flash memory, volatile and non-volatile memory, field programmable gate arrays, multiplexers, and other memory and logic circuitry. The analysis unit 15 may be located within the body 11 of the aircraft 1 to support real-time rotor system structural fault estimation while the aircraft 1 is in normal operation and flight.

Pilot inputs 13 and aircraft state parameters 14 are also received at the analysis unit 15. The pilot inputs 13 can be provided separately or incorporated in the aircraft state parameters 14. The aircraft state parameters 14 can include sensed and/or derived values indicating a current operating state of the aircraft 1. For example, the aircraft state parameters 14 can include pilot inputs 13, and sensor 12 based data such as airspeed, altitude, attitude, acceleration, and other such values. Data from sensors 12 that are incorporated in the aircraft state parameters 14 are typically lower frequency data (e.g., updated once per main rotor 7 revolution of the rotor system 5). Higher frequency data (e.g., multiple samples per main rotor 7 revolution) from sensors 12 that provide a direct indication of rotor system 5 loads and motion are typically handled separately by the analysis unit 15 and are not included in the aircraft state parameters 14. The aircraft state parameters 14 may be determined by a flight management computer (not depicted) and/or other component. In one embodiment, the analysis unit 15 is incorporated in a flight management computer (not depicted). Alternatively, the analysis unit 15 can be a separate component or incorporated in another component, such as a health monitoring unit (not depicted).

According to embodiments of the present invention, sensor data from the sensors 12 may be analyzed by the analysis unit 15 to determine residual values relative to estimated rotor loads and motion of the rotor system 5. The residual values can be monitored over time to detect progressive faults. In a system having a rotating component, such as the rotor blades 10 and rotor shaft 18 of the aircraft 1, the data from the sensors 12 associated with a rotating component is periodic. For example, the sensor data between one revolution and the next of the rotor blades 10 should be very similar if the state of the aircraft 1 has not changed significantly. Sensor outputs for the rotor system 5 are correlated with each other. For example, when the pitch of the rotor blades 10 is changed as a result of a pilot-initiated change in collective position, the output of the sensors 12 will correlate with each other in the sense that the change in loads and motion induced by the change in collective is repeatable under conditions within the linear regime and proportional to the magnitude of the change in collective. The analysis unit 15 gathers a large quantity of data from multiple sensors 12 over the period of one rotor revolution. Under a suitably broad range of flight conditions (i.e., a linear regime) the relationship between the state of the aircraft 1 and the rotor loads and motion is a linear relationship.

Throughout the description below, italicized lower-case letters represent scalar variables, italicized upper-case letters represent matrices, and bold italicized lower-case letters represent vectors. The symbols i, j and n are used to signify integer indices. Certain constants are associated with application of embodiments to a particular helicopter system: m, the number healthy perturbation modes; and nfaults, the number of faults.

In forward flight, rotor loads and motion are a periodic function of the rotor azimuth position ψ, which can be expressed as an angle. Thus any rotor load or motion variable y, as observed under a given aircraft state x, is a quasi-periodic function of ψ and can be expressed as a Fourier series expansion. Complex Fourier coefficients which fully characterize a rotor system load or motion can be expressed as a function of the aircraft state vector x, a function which has a Taylor series expansion around some reference point r. Examples of aircraft state variables which are components of x include pilot inputs, airspeed vector components, attitude, and attitude rates, i.e., the aircraft state parameters 14. By modeling or testing using pre-damaged components including different fault magnitudes, perturbation modes with respect to azimuth ψ for each of the fault magnitudes fⱼ can be expressed according to equation (1) as mⱼ^{fault} (ψ), where aₒ, aₙ, and bₙ, are Fourier coefficients for loads and motion that are linear with respect to fault magnitudes fⱼ.

$${m}_{j}^{fault} ( ψ ) = \frac{\partial {a}_{0}}{\partial {f}_{j}} ( r ) + {\sum }_{n = 1}^{∞} ( \frac{\partial {a}_{n}}{\partial {f}_{j}} ( r ) cos n ψ + \frac{\partial {b}_{n}}{\partial {f}_{j}} ( r ) sin n ψ ) \qquad ( 1 )$$

A complete model for loads and motion can be expressed by equation (2), where y_{ref}(ψ) is a reference mode of the loads and motion from which healthy and fault-based perturbations occur. During normal operation of the aircraft 1, various maneuvers and flight conditions can result in observable perturbations. These normal and expected perturbations, also referred to as healthy perturbation modes, can be modeled according to aircraft vector x and reference point r as

$${\sum }_{i = 1}^{m} {m}_{i} ( ψ ) ( {x}_{i} - {r}_{i} )$$

in equation (2). Therefore, the complete model for loads and motion y(ψ) expressed in equation (2) is the reference mode of the loads and motion plus the healthy perturbation modes plus the fault perturbation modes times the fault magnitudes.

$$y ( ψ ) = {y}_{ref} ( ψ ) + {\sum }_{i = 1}^{m} {m}_{i} ( ψ ) ( {x}_{i} - {r}_{i} ) + {\sum }_{j = 1}^{nfaults} {m}_{j}^{fault} ( ψ ) {f}_{j} \qquad ( 2 )$$

Residual rotor loads and motion can be expressed as a residual waveform z(ψ). After subtracting the reference mode and the healthy perturbation modes from the loads and motion, the resulting residual rotor loads and motion are equal to the fault perturbation modes times the fault magnitudes as expressed in equation (3).

$$z ( ψ ) = y ( ψ ) = {y}_{ref} ( ψ ) - {\sum }_{i = 1}^{m} {m}_{i} ( ψ ) ( {x}_{i} - {r}_{i} ) = {\sum }_{j = 1}^{nfaults} {m}_{j}^{fault} ( ψ ) {f}_{j} \qquad ( 3 )$$

If (as is typically the case) a rotor load or motion is sampled at N discrete intervals over each rotor revolution, then the fault perturbation modes can be expressed as a matrix M_{fault}, and thus, equation (3) can be re-written as an over-determined system of equations (4).

M_{fault}f=z (4)

In the case where there is only one measured load or motion, z is a vector with N elements, f is a vector with nfaults elements, and M_{fault} is an N×nfaults matrix. In the case where there are L measured loads or motions, z is a vector with NL elements including the residuals for each load or motion, sampled over one rotor revolution; f is a vector with nfaults elements; and M_{fault} is an NL×nfaults matrix.

In exemplary embodiments, is odiments, columns of M_{fault} are linearly independent such that the product of the transpose of M_{fault}, i.e., M_{fault}^{T}, and M_{fault} is invertible. Equation (5) is a least squares estimate of the fault magnitude vector \hat{f}.

\hat{f}=(M_{fault}^{T}M_{fault})⁻¹M_{fault}^{T}Z (5)

The fault magnitude vector \hat{f} is an estimate of the fault magnitudes based on a single revolution worth of rotor loads and motion data and can provide a quantitative value to enable fault trending even in a system that includes non-fault-based perturbations, i.e., healthy perturbation modes. The ease of computation enables real-time least squares estimation of fault magnitudes and tracking of multiple fault modes per rotor blade 10.

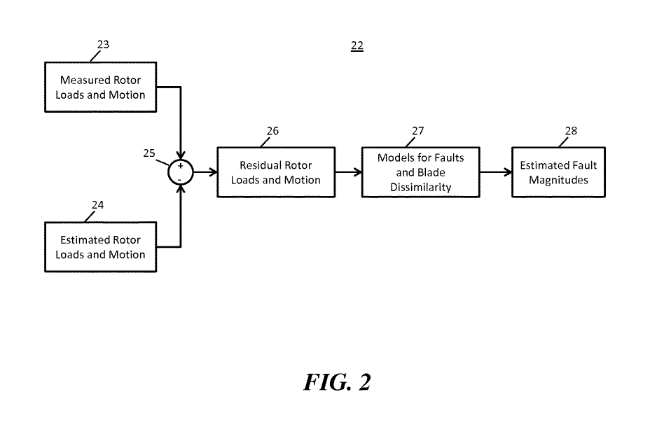

FIG. 2 is a data flow diagram 22 for the structural fault estimation system 20 of FIG. 1 according to an embodiment. The data flow diagram 22 indicates real-time operations performed by the analysis unit 15 of FIG. 1 for real-time rotor system structural fault estimation while the aircraft 1 of FIG. 1 is in operation. The analysis unit 15 of FIG. 1 determines measured rotor loads and motion 23 of the rotor system 5 of FIG. 1 using data from the sensors 12 of FIG. 1. Data from the sensors 12 may be formatted as a waveform per sensed parameter, where each waveform includes multiple samples per revolution. The analysis unit 15 of FIG. 1 can also determine estimated rotor loads and motion 24 as virtual loads based on an increased sampling frequency of aircraft state parameters 14, where a sample rate of the estimated rotor loads and motion 24 is normalized to align with a sample rate of the measured rotor loads and motion 23. At summing junction 25, the estimated rotor loads and motion 24 is subtracted from the measured rotor loads and motion 23 to produce residual rotor loads and motion 26. The analysis unit 15 of FIG. 1 applies least squares as previously described in equation (5) to the residual rotor loads and motion 26 and fault models 27 to produce estimated fault magnitudes 28. In this example, the fault magnitude vector \hat{f} of equation (5) is equivalent to the estimated fault magnitudes 28; matrix M_{fault} is equivalent to fault models 27; transpose matrix M_{fault}^{T} is equivalent to the transpose of fault models 27; and residual z is equivalent to residual rotor loads and motion 26.

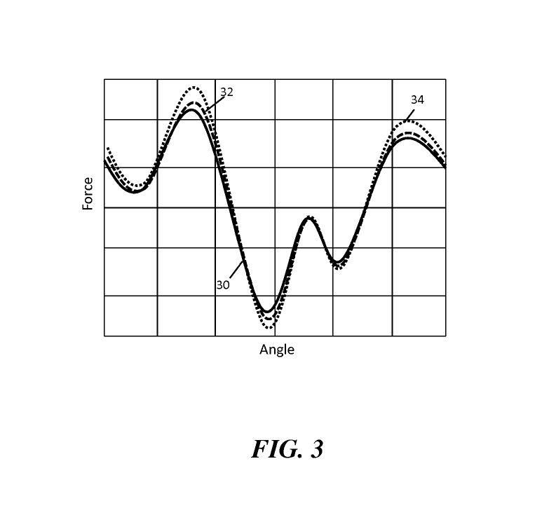

FIG. 3 depicts an example of fault magnitude variation over a range of angles for one example rotor system fault in accordance with embodiments. In FIG. 3, waveform 30 indicates a baseline healthy response for a monitored force over a range of azimuth angles. Waveform 32 indicates a partially faulted component (e.g., 50% healthy) over the same range of azimuth angles. Waveform 34 indicates a highly faulted component (e.g., 10% healthy) over the same range of azimuth angles. As can be seen in this example as a fault increases in a component, a variation in response can be observed. By testing multiple components at various levels of a same failure, e.g., eight levels per failure, a library of faults can be created and stored in a matrix format in the fault models 27 of FIG. 2. A least squares solution that aligns more closely with waveform 34 indicates a greater estimated fault magnitude than a solution that more closely aligns with waveforms 30 or 32.

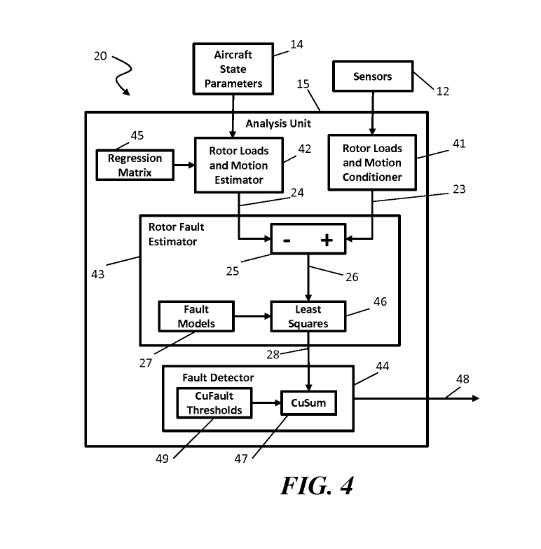

FIG. 4 is a schematic diagram of the exemplary structural fault estimation system 20 of FIG. 1 according to an embodiment. The structural fault estimation system 20 includes an example of the analysis unit 15 of FIG. 1. In the example of FIG. 4, the analysis unit 15 can use the processor 16 and memory 17 of FIG. 1 to implement a rotor loads and motion conditioner 41, a rotor loads and motion estimator 42, a rotor fault estimator 43, and a fault detector 44 to support real-time structural fault estimation for the rotor system 5 of FIG. 1. The rotor loads and motion conditioner 41 can arrange or preprocess data from the sensors 12 to produce the measured rotor loads and motion 23. For example, the rotor loads and motion conditioner 41 may isolate data from multiple sensors 12 to target parameters associated with loads and motion of the rotor system 5 of FIG. 1. The rotor loads and motion conditioner 41 can also apply scaling and engineering unit conversion, e.g., volts/current to force, to data from the sensors 12.

The rotor loads and motion estimator 42 receives the aircraft state parameters 14 that are sampled once per main rotor 7 (FIG. 1) revolution and form a vector of aircraft state parameters 14 that are multiplied by a regression matrix 45 to produce coefficients for orthogonal waveforms. The orthogonal waveforms can be combined to produce high frequency estimates (e.g., about 320 Hz) of rotor loads and motion that align with the measured rotor loads and motion 23. The regression matrix 45 for the orthogonal waveforms can be computed during system modeling to correlate aircraft state parameters 14 with modeled rotor loads and motions as weighted waveform vectors.

The rotor fault estimator 43 includes the summing junction 25, a least squares estimator 46, and fault models 27. The summing junction 25 determines the residual rotor loads and motion 26 as a difference between the measured rotor loads and motion 23 and the estimated rotor loads and motion 24. The least squares estimator 46 determines the estimated fault magnitudes 28 using least squares relative to the fault models 27 and the residual rotor loads and motion 26 according to equation (5) as previously described.

The fault models 27 define a library of fault signatures for a plurality of structural faults of the rotor system 5 of FIG. 1. For example, multiple pitch rod faults, damper faults, and bearing faults can be defined as well as dissimilarity effects of the rotor blades 10 of FIG. 1 when the aircraft 1 of FIG. 1 is in forward flight. Dissimilarities between the rotor blades 10 of FIG. 1 can include twist differences, stiffness differences, center of gravity differences, and mass moment of inertia differences, for example. The fault models 27 can define a range of waveforms for each fault or dissimilarity under analysis. The estimated fault magnitudes 28 represent a singular quantitative solution for the best match for each potential fault defined in the fault models 27 to a particular fault level defined as a fault magnitude. The estimated fault magnitudes 28 are isolated as separate fault conditions per rotor blade 10 of the rotor system 5 of FIG. 1.

The fault detector 44 monitors the estimated fault magnitudes 28 and can apply a cumulative sum detector 47 to identify persistent fault changes over time for each of the estimated fault magnitudes 28. The cumulative sum detector 47 may declare a fault condition 48 when a cumulative sum of a corresponding estimated fault magnitude 28 exceeds a cumulative fault threshold 49. Notification of the fault condition 48 can be provided to another system with the aircraft 1 of FIG.1, such as a pilot indicator, and/or relayed to a maintenance computer (not depicted) which may be internal or external to the aircraft 1 of FIG. 1.

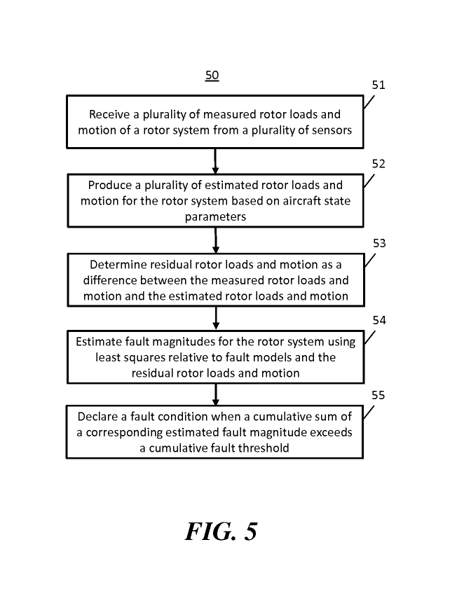

FIG. 5 is a process flow diagram of a method for rotor system structural fault estimation according to an embodiment. Process 50 as depicted in FIG. 5 can include additional elements beyond those depicted in FIG. 5 and may be applicable to elements as described in reference to FIGS. 1-4. For purposes of explanation, the process 50 is described in reference to FIGS. 1-5.

At block 51, the structural fault estimation system 20 receives a plurality of measured rotor loads and motion 23 of the rotor system 5 from a plurality of sensors 12. The measured rotor loads and motion 23 can be received directly as sensor data from sensors 12 on the rotor blades 10 and the rotor shaft 18 and may be further processed by the rotor loads and motion conditioner 41 depending upon formatting constraints.

At block 52, a plurality of estimated rotor loads and motion 24 for the rotor system 5 based on the aircraft state parameters 14 is produced. The estimated rotor loads and motion 24 may be produced by the rotor loads and motion estimator 42 and provided to the rotor fault estimator 43.

At block 53, the structural fault estimation system 20 can determine residual rotor loads and motion 26 as a difference between the measured rotor loads and motion 23 and the estimated rotor loads and motion 24. The difference may be calculated by the summing junction 25.

At block 54, the structural fault estimation system 20 can estimate fault magnitudes for the rotor system 5 using least squares relative to fault models 27 and the residual rotor loads and motion 26. The least squares estimator 46 can use a matrix and transpose matrix approach for determining the estimated fault magnitudes 28. A cumulative sum detector 47 may be used to identify persistent fault changes over time for each of the estimated fault magnitudes 28.

At block 55, the structural fault estimation system 20 can declare a fault condition 48 when a cumulative sum of a corresponding estimated fault magnitude 28 exceeds a cumulative fault threshold 49.

Technical effects include detection of structural faults through loads and motion, as well as fault magnitude estimation of the faults. Rotor system structural fault estimation accommodates variability of loads and motion that is inherent with variability in aircraft flight conditions by accounting for healthy perturbations in the estimation process.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A structural fault estimation system for a rotor system, the structural fault estimation system comprising:
a plurality of sensors operable to provide a plurality of measured rotor loads and motion of the rotor system;
a rotor loads and motion estimator operable to produce a plurality of estimated rotor loads and motion for the rotor system; and
a rotor fault estimator operable to determine residual rotor loads and motion as a difference between the measured rotor loads and motion and the estimated rotor loads and motion, and estimate fault magnitudes for the rotor system using least squares relative to fault models and the residual rotor loads and motion.

2. The structural fault estimation system according to claim 1, wherein the fault models comprise a library of fault signatures for a plurality of structural faults of the rotor system.

3. The structural fault estimation system according to claim 1, wherein the estimated rotor loads and motion for the rotor system are estimates based on an increased sampling frequency of aircraft state parameters.

4. The structural fault estimation system according to claim 3, wherein the aircraft state parameters are updated once per main rotor revolution of the rotor system.

5. The structural fault estimation system according to claim 4, wherein a sample rate of the estimated rotor loads and motion is normalized to align with a sample rate of the measured rotor loads and motion.

6. The structural fault estimation system according to claim 1, wherein the estimated fault magnitudes are isolated as separate fault conditions per rotor blade of the rotor system.

7. The structural fault estimation system according to claim 1, further comprising a fault detector that applies a cumulative sum detector to identify persistent fault changes over time for each of the estimated fault magnitudes.

8. The structural fault estimation system according to claim 7, wherein the cumulative sum detector declares a fault condition when a cumulative sum of a corresponding estimated fault magnitude exceeds a cumulative fault threshold.

9. A method of rotor system structural fault estimation, the method comprising:
receiving a plurality of measured rotor loads and motion of a rotor system from a plurality of sensors;
producing a plurality of estimated rotor loads and motion for the rotor system based on aircraft state parameters;
determining residual rotor loads and motion as a difference between the measured rotor loads and motion and the estimated rotor loads and motion; and
estimating fault magnitudes for the rotor system using least squares relative to fault models and the residual rotor loads and motion.

10. The method according to claim 9, wherein the fault models comprise a library of fault signatures for a plurality of structural faults of the rotor system.

11. The method according to claim 9, wherein the estimated rotor loads and motion for the rotor system are estimates based on an increased sampling frequency of the aircraft state parameters.

12. The method according to claim 11, wherein the aircraft state parameters are updated once per main rotor revolution of the rotor system.

13. The method according to claim 12, wherein a sample rate of the estimated rotor loads and motion is normalized to align with a sample rate of the measured rotor loads and motion.

14. The method according to claim 9, wherein the estimated fault magnitudes are isolated as separate fault conditions per rotor blade of the rotor system.

15. The method according to claim 9, further comprising:
applying a cumulative sum detector to identify persistent fault changes over time for each of the estimated fault magnitudes; and
declaring a fault condition when a cumulative sum of a corresponding estimated fault magnitude exceeds a cumulative fault threshold.

16. The method according to claim 9, wherein the receiving a plurality of measured rotor loads and motion of a rotor system from a plurality of sensors includes preprocessing data from the sensors to produce the measured rotor loads and motion.
